(19) United States
(12) Patent Application Publication
(10) Pub. No.: US 2021/0316785 A1
(43) Pub. Date: Oct. 14, 2021

(54) VEHICLE

(71) Applicants: Kanzaki Kokyukoki Mfg. Co., Ltd., Amagasaki (JP); Yanmar Holdings Co., Ltd., Osaka (JP)

(72) Inventors: Kohei OGURA, Amagasaki (JP); Koji KIYOOKA, Amagasaki (JP); Hidetaka YAMANAMI, Amagasaki (JP); Kenji OGATA, Osaka (JP); Yuya KUROIWA, Osaka (JP)

(21) Appl. No.: 17/226,197

(22) Filed: Apr. 9, 2021

(30) Foreign Application Priority Data
Apr. 14, 2020 (JP) 2020-072092

(51) Int. Cl. B62D 11/00; A01D 34/64; A01D 34/82; B62D 11/04; B62D 1/12

(52) U.S. Cl. CPC B62D 11/003; A01D 34/64; A01D 2101/00; B62D 11/04; B62D 1/12; A01D 34/824

(57) ABSTRACT

To provide a vehicle including a left continuously variable transmission connected to a left wheel and a right continuously variable transmission connected to a right wheel, at least one operation tool operated to instruct driving of the left wheel and the right wheel, a control device configured to control driving of the left continuously variable transmission and the right continuously variable transmission according to an operation of the at least one operation tool, and a turn operation tool provided on each of the at least one operation tool. If the turn operation tool is operated, the control device controls the left continuously variable transmission and the right continuously variable transmission so that the vehicle is turned to a side of the operated turn operation tool.

### CROSS REFERENCE TO RELATED APPLICATIONS

This application claims priority to Japanese Patent Application No. 2020-072092 filed on Apr. 14, 2020, which is incorporated herein by reference in its entirety including the specification, claims, drawings, and abstract.

### BACKGROUND

### Technical Field

The present disclosure relates to a vehicle including a left continuously variable transmission connected to a left wheel, a right continuously variable transmission connected to a right wheel, and at least one operation tool.

### Related Art

There is conventionally known a lawn mowing vehicle equipped with a lawnmower driven to perform lawn mowing work. Further, there is proposed such a lawn mowing vehicle including a left wheel and a right wheel independently driven to travel by an electric motor and caster wheels.

Further, an example of the lawn mowing vehicle includes a lawn mowing vehicle allowing a worker to ride therein to perform thereon an operation for traveling and mowing, and capable of traveling under its own power, and this type of vehicle is called a riding-type lawn mowing vehicle. An example of the lawnmower includes a rotary blade type lawnmower rotary tool equipped with a propeller.

The riding-type lawn mowing vehicle is used exclusively in so-called off-road situations such as in a garden, and moves on a ground surface for mowing work.

For example, Japanese Unexamined Patent Application No. 2014-045637 describes a riding-type electric lawn mowing vehicle including traveling motors, which are left and right electric motors, being connected to a wheel at a corresponding side, where two left and right wheels are driven to travel independently by the two left and right traveling motors. Two operation levers on both left and right sides of a driver's seat instruct the two left and right traveling motors to rotate.

In the configuration described in Japanese Unexamined Patent Application No. 2014-045637, a main controller calculates a target rotation speed of the two left and right traveling motors from a detection value of a swing angle of the two operation levers and a motor controller controls an inverter so that the traveling motors rotate at respective target rotation speeds. As a result, when a driver changes a swing amount of the two operation levers, it is possible to turn the vehicle. However, the driver must move their arm to change the swing amount of the operation levers each time the driver turns the vehicle, and thus, the driver's arm easily gets tired during driving, especially during long-distance or long-time driving.

Further, in the configuration described in Japanese Unexamined Patent Application No. 2014-045637, acceleration and deceleration during operation of the operation levers cannot be adjusted arbitrarily by a user, and thus, there is room for improvement in terms of improving the ease of driving and working of the user.

Further, in the configuration described in Japanese Unexamined Patent Application No. 2014-045637, if the vehicle is turned by operating only one of the two operation levers, when turning the inside wheel is stopped from rotating, and thus, if the vehicle travels on grass, the grass may be possibly damaged as a result of a lawn being significantly twisted by the inside wheel when turning. This leaves room for improvement in terms of enabling turning while protecting grass when traveling on the grass.

### SUMMARY

A first object of the present disclosure is to reduce fatigue of a driver's arm in a vehicle provided with at least one operation tool for driving two left and right wheels. Further, a second object of the present disclosure is to improve ease of driving and working of a user. A third object of the present disclosure is to enable turning while protecting grass when traveling on the grass.

A first vehicle according to the present disclosure is a vehicle including a left continuously variable transmission connected to a left wheel and a right continuously variable transmission connected to a right wheel, the left continuously variable transmission and the right continuously variable transmission being to drive the left wheel and the right wheel independently with regards to a rotation direction and a rotation speed, at least one operation tool operated to instruct driving of the left wheel and the right wheel, a control device to control driving of the left continuously variable transmission and the right continuously variable transmission according to operation of the at least one operation tool, and a turn operation tool provided on the at least one operation tool. When the turn operation tool is operated, the control device controls the left continuously variable transmission and the right continuously variable transmission to turn the vehicle to a side in which the turn operation tool is operated.

A second vehicle according to the present disclosure is a vehicle including a left continuously variable transmission connected to a left wheel and a right continuously variable transmission connected to a right wheel, the left continuously variable transmission and the right continuously variable transmission being to drive the left wheel and the right wheel independently for a rotation direction and a rotation speed, at least one operation tool operated to instruct driving of the left wheel and the right wheel, a control device to control driving of the left continuously variable transmission and the right continuously variable transmission according to operation of the at least one operation tool, and an acceleration/deceleration adjustment tool. The control device sets target rotation speed of each of the left continuously variable transmission and the right continuously variable transmission according to operation positions of the at least one operation tool, and if the acceleration/deceleration adjustment tool is operated and the at least one operation tool is operated, the control device changes, according to the operation of the acceleration/deceleration adjustment tool, a responsiveness used when a current rotation speed of the left continuously variable transmission or the right continuously variable transmission corresponding to the operated operation tool shifts to the target rotation speed.

A third vehicle according to the present disclosure is a vehicle including a left continuously variable transmission connected to a left wheel and a right continuously variable transmission connected to a right wheel, the left continuously variable transmission and the right continuously variable transmission being to drive the left wheel and the right wheel independently for a rotation direction and a rotation speed, at least one operation tool operated to instruct driving of the left wheel and the right wheel, a control device to control driving of the left continuously variable transmission and the right continuously variable transmission according to an operation of the at least one operation tool, and a lawn protection operation tool operable by a driver. The control device sets target rotation speeds of the left continuously variable transmission and the right continuously variable transmission according to operation positions of the at least one operation tool, and if the lawn protection operation tool is operated and the operation tool is operated, when turning, the control device rotates one inside wheel, of the left wheel and the right wheel, at a speed lower than that of the other outside wheel when turning to a side that is the same as or opposite with regard to rotational direction to the other outside wheel.

### BRIEF DESCRIPTION OF THE DRAWINGS

Embodiment(s) of the present disclosure will be described based on the following figures, wherein:

FIG. 1 is a perspective view of a vehicle according to an embodiment of the present disclosure;

FIG. 2 is a diagram illustrating a schematic configuration of the vehicle according to the embodiment;

FIG. 3 is a diagram illustrating a right operation lever and an operation element group in the vehicle of according to the embodiment;

FIG. 4 is a block diagram illustrating a characteristic configuration of the vehicle according to the embodiment;

FIG. 5 is a schematic diagram illustrating a state of straight travel in the vehicle according to the embodiment;

FIG. 6A is a schematic diagram illustrating a state of left turn traveling to a front side in the vehicle according to the embodiment;

FIG. 6B is a schematic diagram illustrating a state in which the vehicle turns around one wheel, of two left and right wheels, in the vehicle according to the embodiment;

FIG. 6C is a schematic diagram illustrating a state in which the vehicle quickly turns about a center between the two left and right wheels in the vehicle according to the embodiment;

FIG. 7 is a block diagram illustrating a configuration in which corrected target revolution speeds of the two left and right motors are set if a turn switch is operated in the vehicle according to the embodiment;

FIG. 8 is a diagram illustrating an example over time in which the corrected target revolution speeds of the two left and right motors are set if a right-side turn switch is operated during forward straight travel;

FIG. 9 is a schematic diagram of an example of a state in which the right-side turn switch is operated to make a U-turn in the vehicle according to the embodiment, as viewed from above with the vehicle assumed to be at traveling positions at a plurality of time points;

FIG. 10 is an enlarged diagram of A of FIG. 9;

FIG. 11 is a block diagram illustrating a configuration in which target revolution speeds of the two left and right motors are subject to a filtering process when a response adjustment dial is operated in the vehicle according to the embodiment;

FIG. 12 is a graph showing two examples over time when the target revolution speeds of the two left and right motors are subject to the filtering process according to an operation of the response adjustment dial in the vehicle according to the embodiment;

FIG. 13 is a diagram corresponding to FIG. 3 in another exemplary vehicle according to the embodiment of the present disclosure;

FIG. 14 is a diagram corresponding to FIG. 3 in another exemplary vehicle according to the embodiment of the present disclosure;

FIG. 15 is a diagram corresponding to FIG. 3 in another exemplary vehicle according to the embodiment of the present disclosure; and

FIG. 16 is a diagram corresponding to FIG. 3 in another exemplary vehicle according to the embodiment of the present disclosure.

### DESCRIPTION OF EXEMPLARY EMBODIMENTS

Embodiments according to the present disclosure will be described in detail below with reference to the drawings. A case where left and right wheels are arranged on a rear side and caster wheels are arranged on a front side will be described below, but the wheels may be arranged on the front side and the caster wheels may be arranged on the rear side.

Shapes, numbers, arrangement relations between parts, and the like described below are examples for explanation and may be appropriately changed according to the specifications of a vehicle or the like. It is noted that a case where the vehicle is an electric lawn mowing vehicle will be described below, but the vehicle may be a vehicle without a lawnmower. Also, similar elements are designated by the same reference numerals in all the drawings, and duplicated description will be omitted or simplified.

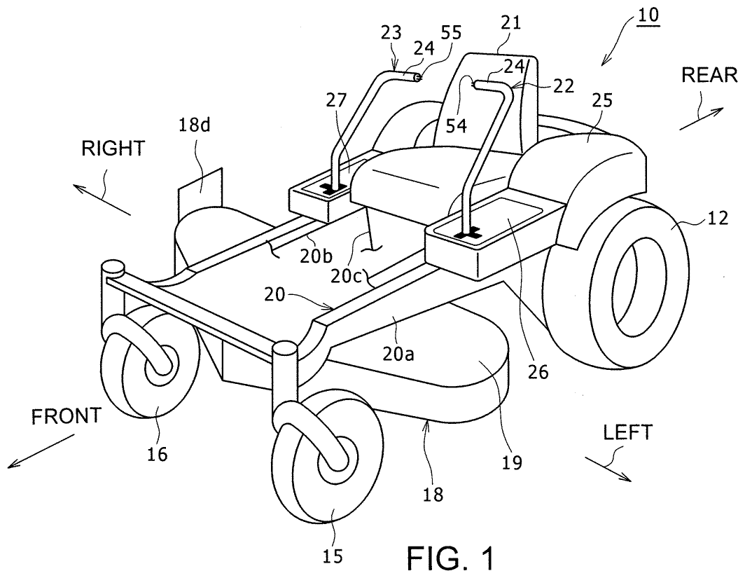

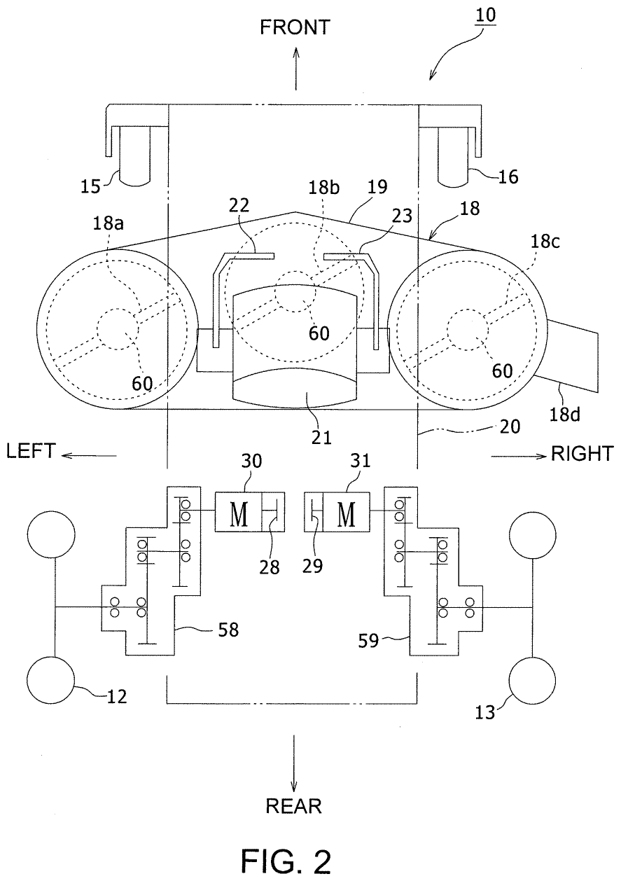

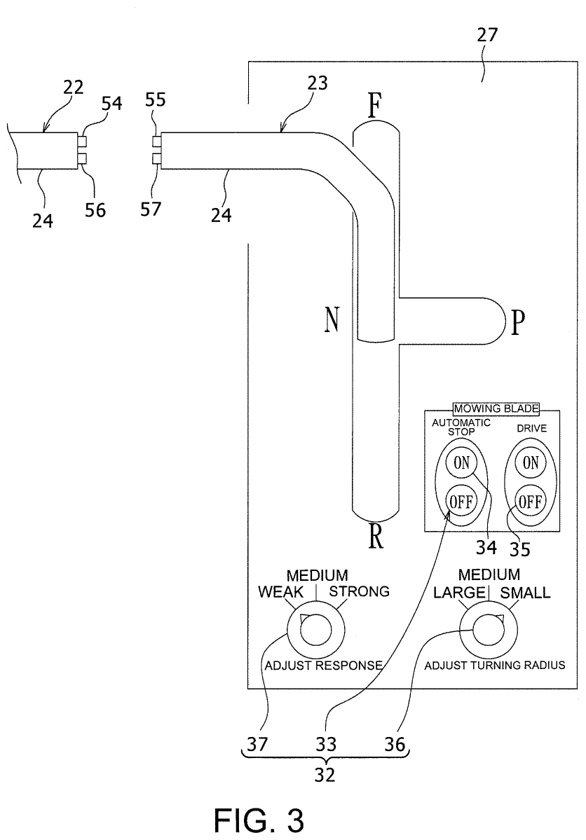

FIG. 1 to FIG. 10 illustrate a vehicle 10 according to an embodiment. FIG. 1 is a perspective view of the vehicle 10. FIG. 2 is a diagram illustrating a schematic configuration of the vehicle 10. FIG. 3 is a diagram illustrating a right operation lever 23 and an operation element group 32 in the vehicle 10.

The vehicle 10 is an autonomous off-road vehicle suitable for lawn mowing, and is an electric lawn mowing vehicle. The vehicle 10 may be a lawn care vehicle.

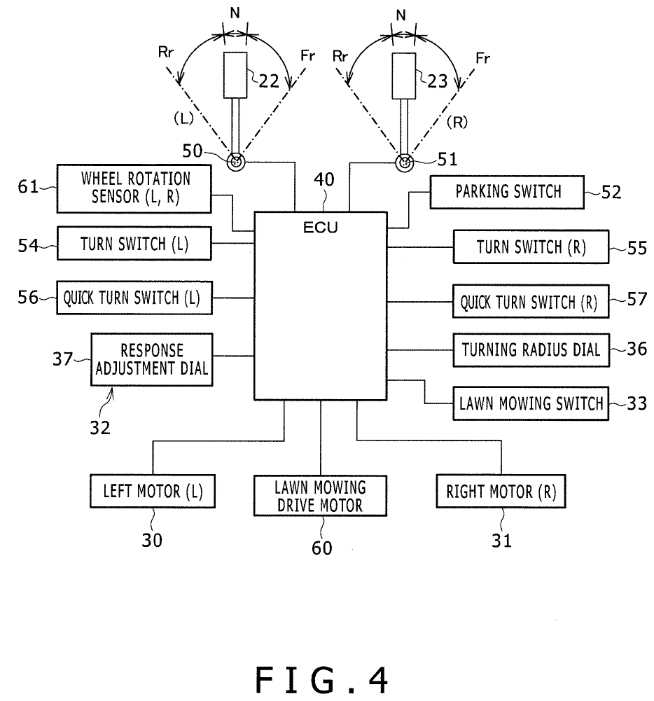

The vehicle 10 includes a left wheel 12 and a right wheel 13 (FIG. 2), caster wheels 15 and 16, a lawnmower 18, a left motor 30 and a right motor 31 (FIG. 2), two left and right operation levers 22 and 23, and an ECU 40 (FIG. 4) being a control device. The left motor 30 is an example of a left continuously variable transmission, and the right motor 31 is an example of a right continuously variable transmission.

The left wheel 12 and the right wheel 13 are rear wheels supported on both left and right sides on the rear side of a main frame 20 being a vehicle body, and are main driving wheels. The main frame 20 is a metal such as a steel material, formed into a beam structure or the like. The main frame 20 includes side plates 20a and 20b extending substantially in a front-rear direction at both left and right ends, and a coupling portion 20c coupling both the left and right side plates 20a and 20b. A driver's seat 21 on which a driver sits is fixed on a space between the rear ends of the left and right side plates 20a and 20b.

In the main frame 20, two guide panels 26 and 27 are fixed on both the left and right sides of the driver's seat 21, and are supported by the main frame 20 so that the two left and right operation levers 22 and 23 project upward from each of the two guide panels 26 and 27. The distal end of each of the operation levers 22 and 23 is grasped by the driver and is used to instruct a rotation direction and a rotation speed of the left wheel 12 and the right wheel 13. The left operation lever 22 is operated to instruct driving and accelerating of the left wheel 12 by changing an instruction of the rotation speed of the left wheel 12 so that the rotation speed is high. The right operation lever 23 is operated to instruct driving and accelerating of the right wheel 13 by changing an instruction of the rotation speed of the right wheel 13 so that the rotation speed is high. The operation levers 22 and 23 are substantially L-shaped, and a grip 24 extending in a left-right direction is formed at the upper end. The grip 24 is gripped and operated by the driver. The operation levers 22 and 23 are swingable around an axis along the left-right direction at the lower end. As illustrated in FIG. 3, when the operation levers 22 and 23 are tilted in an F direction corresponding to a forward movement with reference to an N position being a neutral position close to an upright position, they instruct the motor 30 (or the motor 31) at the side same as that of the operation lever 22 (or 23) to drive at a target revolution speed (min−1) per unit time as a target rotation speed corresponding to the forward movement. The operation levers 22 and 23 instruct to increase the target revolution speed as an amount of tilt increases. On the other hand, when the operation levers 22 and 23 are tilted in an R direction corresponding to a backward movement with reference to the N position, they instruct the motor 30 (or 31) at the side same as that the operation lever 22 (or 23) to drive at a target revolution speed corresponding to the backward movement, and also to drive at a higher target revolution speed as an amount of tilt increases.

One or both of the operation levers 22 and 23 in the N position instruct the motor 30 (or 31) at the side same as that of one of the operation levers 22 (or 23) or both the motors 30 and 31 to drive at the target revolution speed of 0. As a result, if the two left and right operation levers 22 and 23 are in the N position when the vehicle 10 is on a slope, the revolution speed of the motors 30 and 31 is maintained at 0 to prevent the vehicle 10 from sliding down. The N position of the operation levers 22 and 23 may be defined, instead of being defined as a single point, to have a predetermined range in which the operation levers 22 and 23 tilt by a predetermined angle in the front-rear direction with the upright position of the operation levers 22 and 23 as the center, as illustrated in a range indicated by an arrow N in FIG. 4. For example, the operation levers 22 and 23 in the predetermined range instruct the corresponding motors 30 and 31 to drive at the target revolution speed of 0. When the operation levers 22 and 23 are in the N position or within a predetermined range around the N position, the motors 30 and 31 corresponding to the operation levers 22 and 23 may be controlled not to generate a driving force.

When the two left and right operation levers 22 and 23 are in a P position, electromagnetic brakes 28 and 29 (FIG. 2) built into both the motors 30 and 31 are activated to stop rotation of the motors 30 and 31. When the operation levers 22 and 23 are in the P position, members constituting a power transmission path between the motors 30 and 31 and the wheels 12 and 13, for example, gears constituting a reduction gear, may be mechanically stopped, or the wheels 12 and 13 may be braked by actuating a disc brake provided in the wheels 12 and 13.

A swing position of the two left and right operation levers 22 and 23 between the F position and an R position is detected by lever position sensors 50 and 51 (FIG. 4), respectively. The lever position sensors 50 and 51 include, for example, a potentiometer. A parking switch 52 detects that the two left and right operation levers 22 and 23 are in the P position. Signals detected by the lever position sensors 50 and 51 and the parking switch 52 are transmitted to the ECU 40.

As illustrated in FIG. 3, turn switches 54 and 55 serving as turn operation tools are provided on the two left and right operation levers 22 and 23, respectively. The two left and right turn switches 54 and 55 are used to instruct the vehicle 10 to turn to the side of one of the operated turn switches 54 (or 55). The turn switch 54 (or 55) is a push button-type switch protruding from a distal end surface of the grip 24 of each of the operation levers 22 and 23.

The turn switches 54 and 55 are, for example, momentary switches connected to the ECU 40 by a signal line, and continue to output a turn instruction signal to the ECU 40 only when depressed by the driver. When the turn switches 54 and 55 are not depressed, the turn switches 54 and 55 do not output a turn instruction signal to the ECU 40. When the turn instruction signal is transmitted, the ECU 40 changes the target revolution speed (min−1) per unit time as a target rotation speed of the left and right motors 30 and 31 to turn the vehicle 10 to the side of the turn switch 54 (or 55) that transmits the turn instruction signal. As a result, as will be described later, by simply operating the turn switch 54 (or 55) provided on one operation lever 22 (or 23) of the operation levers without changing the operation amount of the two operation levers 22 and 23, the vehicle 10 can be turned to the side of the operated turn switch 54 (or 55). Therefore, the frequency with which the driver moves their arm significantly during driving is reduced, so that the fatigue of the driver's arm is reduced. The turn operation using the turn switches 54 and 55 will be described in detail later.

Further, on the distal end surface of the grip 24 of each of the two left and right operation levers 22 and 23, quick turn switches 56 and 57 serving as quick turn operation tools are provided alongside the turn switches 54 and 55. The quick turn switches 56 and 57 are used to instruct the vehicle 10 to turn quickly to a side of the operated quick turn switch 56 (or 57) with the center position between the ground contact positions of the left wheel 12 and the right wheel 13 being the turning center. In this case, the “quick turn” is called a zero turn or an ultra-pivotal turn. Similarly to the turn switches 54 and 55, the quick turn switches 56 and 57 are push button-type switches protruding from the distal end surface of the grip 24 of the operation levers 22 and 23. The quick turn switches 56 and 57 are, for example, momentary switches connected to the ECU 40 by a signal line, and continue to output a quick turn instruction signal to the ECU 40 only when depressed by the driver. When the quick turn switches 56 and 57 are not depressed, they do not output a quick turn instruction signal to the ECU 40.

The left wheel 12 and the right wheel 13 protrude outward from the outer ends in the left-right direction of the side plates 20a and 20b of the main frame 20. At least a part of the upper side of each of the wheels 12 and 13 is covered with the wheel cover 25, and the wheel cover 25 is fixed to the side plates 20a and 20b. Although the wheel cover 25 and the guide panels 26 and 27 are fixed integrally, the wheel cover 25 and the guide panels 26 and 27 may be separately fixed to the main frame 20.

The two left and right caster wheels 15 and 16 are steering wheels supported by a leading end of the main frame 20, and are the front wheels. Each of the caster wheels 15 and 16 is provided away from the left wheel 12 and the right wheel 13 in the front-rear direction, in the front-rear direction of the vehicle 10. Each of the caster wheels 15 and 16 is freely rotatable through 360 degrees or more about an axis in a vertical direction (in an up-down direction in FIG. 1). The caster wheels are not limited to the configuration in which two caster wheels are arranged in the vehicle, and only one, or three or more, caster wheels may be arranged in the vehicle.

As illustrated in FIG. 2, the left motor 30 is connected to the left wheel 12 via a left reduction gear device 58 supported on the rear side of the main frame 20. The right motor 31 is connected to the right wheel 13 via a right reduction gear device 59 supported on the rear side of the main frame 20. The left motor 30 and the right motor 31 are each traveling motors, and are supported on the left side and the right side, on the rear side of the main frame 20, respectively. Power is supplied from a battery to the left motor 30 and the right motor 31. The left motor 30 and the right motor 31 are independently controlled in terms of the rotation direction and the rotation speed by an ECU, being a control device that will be described later. The left motor 30 and the right motor 31 are, for example, three-phase motors, and are connected to a battery (not illustrated) via an inverter (not illustrated) connected to each of the left motor 30 and the right motor 31. The ECU 40 controls drive of each of the left and right motors 30 and 31 by controlling the inverter corresponding to each of the two left and right motors 30 and 31. As a result, the left motor 30 and the right motor 31 independently drive the left wheel 12 and the right wheel 13 in terms of the rotation direction and the rotation speed. Each of the left motor 30 and the right motor 31 includes the electromagnetic brakes 28 and 29 built therein, and the electromagnetic brakes 28 and 29 are controlled by the ECU 40 (FIG. 4) which will be described later. When the two left and right operation levers 22 and 23 are moved to the parking position P (FIG. 3), the movement is detected by two left and right parking switches 52. A signal detected by the parking switch 52 is transmitted to the ECU 40. In response to turning ON of the two left and right parking switches 52, the ECU 40 actuates the electromagnetic brakes 28 and 29 built into the left and right motors 30 and 31 to stop each of the motors 30 and 31. Various structures such as a friction type structure using a friction plate and a meshing type structure using a meshing plate may be employed for the electromagnetic brakes 28 and 29.

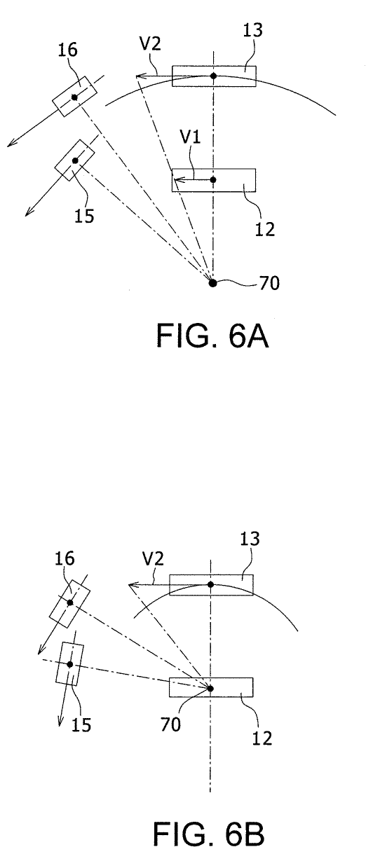

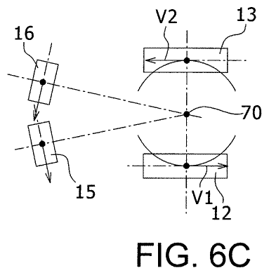

As will be described later, the two left and right wheels 12 and 13 rotate in opposite directions to each other at the same speed, so that the vehicle 10 can make a quick turn around a turning center position 70 (FIG. 6C) located at an intermediate position between the left wheel 12 and the right wheel 13.

As illustrated in FIG. 1 and FIG. 2, the lawnmower 18 is supported below an intermediate area in a longitudinal direction of the main frame 20. The lawnmower 18 is arranged between the caster wheels 15 and 16 and the left and right wheels 12 and 13, in the front-rear direction. The lawnmower 18 includes three lawn mowing blades 18a, 18b, and 18c (FIG. 2), being lawnmower rotary tools arranged within a mower deck 19 that is a cover. The upper side of the lawn mowing blades 18a, 18b, and 18c are covered with the mower deck 19. Each of the lawn mowing blades 18a, 18b, and 18c has a plurality of blade elements that rotate around an axis oriented in the vertical direction (in the front-back direction of the paper surface in FIG. 2). As a result, the blade elements rotate to cut grass and mow the lawn. Each of the lawn mowing blades 18a, 18b, and 18c is rotationally driven by a lawn mowing drive motor 60 (FIG. 4) controlled by the ECU 40 (FIG. 4) described later. The mowed grass is discharged to one side of the vehicle 10 in the left-right direction through a discharge duct 18d provided on one side of the mower deck 19 in the left-right direction.

Both the ends in the left-right direction of the mower deck 19 project outward from both the left and right ends of the left and right side plates 20a and 20b respectively at an intermediate portion in the front-rear direction of both the left and right side plates 20a and 20b (FIG. 1) constituting the main frame 20.

FIG. 4 is a block diagram illustrating a characteristic configuration of the vehicle 10. With reference to FIGS. 3 and 4, the operation element group 32 is arranged on the rear side (lower side of FIG. 3) of the guide panel 27 configured to guide the operation lever 23 on the right side. The operation element group 32 includes a lawn mowing switch 33, a turning radius dial 36, and a response adjustment dial 37. The lawn mowing switch 33 includes an automatic stop changeover switch 34 and a drive changeover switch 35. The automatic stop changeover switch 34 is selectively changeable between an ON switch and an OFF switch, and only ON or OFF function of the last operation for depressing down the switch is enabled. The automatic stop changeover switch 34 is connected to the ECU 40 (FIG. 4) by a signal line.

If the automatic stop changeover switch 34 is turned ON, the ECU 40 stops driving of the lawnmower 18 when the two left and right operation levers 22 and 23 are in the N position.

Similarly to the automatic stop changeover switch 34, the drive changeover switch 35 is also selectively changeable between an ON switch and an OFF switch. The drive changeover switch 35 is also connected to the ECU 40 by a signal line. When the drive changeover switch 35 is turned ON, the lawnmower 18 is driven as intended by the driver regardless of the position of the operation levers 22 and 23. When the drive changeover switch 35 is turned OFF, the lawnmower 18 is stopped as intended of the driver. As a result, the driver can arbitrarily switch between driving and stopping of the lawnmower 18 by using the drive changeover switch 35.

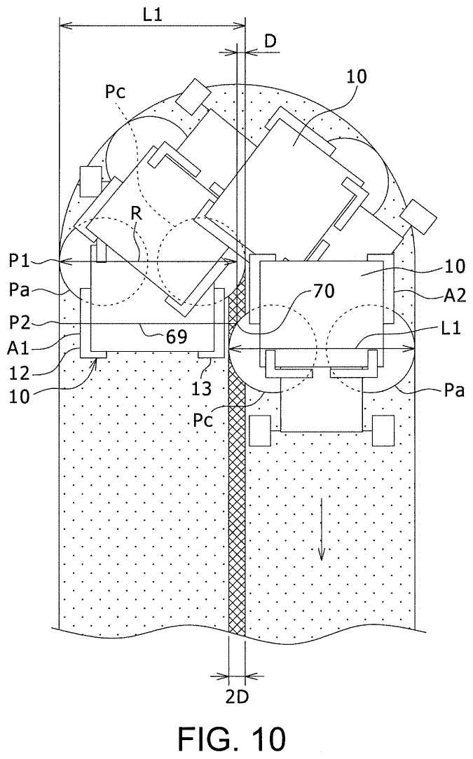

The turning radius dial 36 is a turning radius adjustment tool operable by the driver, and is configured so that any one of the three positions of “Large”, “Medium”, and “Small” can be selected by rotating the dial. “Large”, “Medium”, and “Small” refer to the magnitude of the turning radius when the turn switches 54 and 55 are operated, and the selection of “Large” indicates that the turning radius is set to maximum, the selection of “Small” indicates that the turning radius is set to minimum, and the selection of “Medium” indicates that the turning radius is set to an intermediate level between “Large” and “Small”. As illustrated in FIG. 10 which will be described later, the “turning radius” herein refers to a distance from the turning center position 70 on a ground contact center line 69, being a straight line that connects the center positions in the front-rear direction of the ground contact position of the two left and right wheels 12 and 13 up to a position P2 on the ground contact center line 69, in which the position P2 is aligned in the left-right direction with an outermost end P1 of a rotation trajectory Pa of the lawn mowing blade at the outer side of the turn. In FIG. 10, the turning radius is indicated by R.

The turning radius dial 36 detects the changeover between the three positions by the changeover of the contacts or the like, and transmits the resultant detection signal to the ECU 40. The ECU 40 sets the target turning radius according to the detection signal from the turning radius dial 36. As a result, the ECU 40 changes the target turning radius when the turn switches 54 and 55 (FIG. 3) are operated, to a turning radius among the three predetermined turning radii, according to the operation position of the turning radius dial 36. The ECU 40 calculates the target revolution speed of each of the two left and right motors 30 and 31, based on the target turning radius and the current revolution speed of the two left and right motors 30 and 31 set by the two operation levers 22 and 23, or the revolution speed of the left and right wheels 12 and 13. The ECU 40 controls each of the motors 30 and 31 via an inverter (not illustrated) to drive the motors 30 and 31 at the calculated target revolution speed. The turning radius dial may be switchable so that the size can be selected at two positions, or at four or more positions.

As illustrated in FIG. 4, the detection values of the revolution speeds of the two left and right wheels 12 and 13 are input to the ECU 40 from the left and right wheel rotation sensors 61. Further, the detection values of the revolution speeds of the two left and right motors 30 and 31 are input to the ECU 40 from left and right motor revolution speed sensors (not illustrated).

As illustrated in FIG. 3, the response adjustment dial 37 is an acceleration/deceleration adjustment tool to be operated by the driver, and is configured to select any one of the three positions of “Weak”, “Medium”, and “Strong” by rotating the dial. “Weak”, “Medium”, and “Strong” refer to the level of responsiveness when each of the two left and right motors 30 and 31 shifts to the target revolution speed per unit time as the target rotation speed, when at least one of the operation levers 22 and 23, the turn switches 54 and 55, and the quick turn switches 56 and 57 are operated. The selection of “Weak” indicates that the responsiveness is set to the lowest level, the selection of “Strong” indicates that the responsiveness is set to the highest level, and the selection of “Medium” indicates that the responsiveness is set to an intermediate level between “Weak” and “Strong”. The response adjustment dial 37 detects the changeover between the three positions by the changeover of the contacts or the like, and transmits the resultant detection signal to the ECU 40. The ECU 40 sets the responsiveness when the two left and right motors 30 and 31 shift to the target revolution speed of the two left and right motors 30 and 31 according to the detection signal from the response adjustment dial 37. As a result, the ECU 40 changes the responsiveness of the two left and right motors 30 and 31 to a responsiveness among the three predetermined levels of responsiveness according to the operation position of the response adjustment dial 37.

When each of the two left and right motors 30 and 31 shifts to the target revolution speed set according to the operation of at least one of the operation levers 22 and 23, the turn switches 54 and 55, and the quick turn switches 56 and 57, the ECU 40 shifts each of the two left and right motors 30 and 31 from the current revolution speed to the target revolution speed with the set responsiveness. For example, the ECU 40 sets the target revolution speed of the two left and right motors 30 and 31 according to the operation position of the two operation levers 22 and 23.

More specifically, the ECU 40 (FIG. 4) includes a calculation unit such as a CPU and a storage unit such as a memory, and is composed of, for example, a microcomputer. The ECU 40 acquires the operation position of the two operation levers 22 and 23 from the detection signals of the two left and right lever position sensors 50 and 51, and sets the target revolution speed of each of the left motor 30 and the right motor 31 according to the operation position of each of the operation levers 22 and 23.

Further, when the response adjustment dial 37 is operated and at least one of the two operation levers 22 and 23 is operated, the ECU 40 changes the responsiveness in shifting from the current rotation speed of the left motor 30 or the right motor 31 corresponding to the operated operation levers 22 and 23 to the target rotation speed, according to the operation of the response adjustment dial 37. Thus, for example, during control for setting the target revolution speed, when the ECU 40 gradually shifts the motors 30 and 31 to the target revolution speed by filtering, the ECU 40 performs the processing based on a filtered responsiveness. For example, a gain employed when feedback control is performed so that the revolution speed of the motors 30 and 31 approaches the target revolution speed by filtering according to the detection value of the current revolution speed of the motors 30 and 31 is changed based on the set responsiveness. For example, when “Strong” is set, the gain is set to the largest gain among three predetermined gains, when “Weak” is set, the gain is set to the smallest gain among the three predetermined gains, and when “Medium” is set, the gain is set to an intermediate gain between “Strong” and “Weak”.

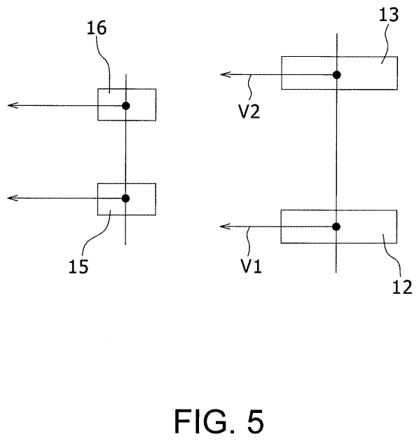

FIG. 5 is a schematic diagram illustrating a state of a straight travel in the vehicle 10. FIG. 5 illustrates a positional relationship between the left and right wheels 12 and 13 and the caster wheels 15 and 16. As illustrated in FIG. 5, if the rotation speeds of the left and right wheels 12 and 13 are matched by the left and right motors 30 and 31 (FIG. 2), the straight travel of the vehicle 10 is possible. At this time, the ground movement speeds V1 and V2 of the left and right wheels 12 and 13, being the movement speeds at the ground contact position with respect to the ground, are the same. A power source is not connected to the left and right caster wheels 15 and 16, and the caster wheels 15 and 16 are rotated from the ground following travel of the vehicle 10 by driving the left and right wheels 12 and 13. On the other hand, a difference in rotation speeds between the left and right wheels 12 and 13 enables turn traveling of the vehicle 10.

FIGS. 6A, 6B, and 6C illustrate three examples of turn traveling of the vehicle. FIGS. 6A, 6B, and 6C also illustrate a positional relationship between the left and right wheels 12 and 13 and the caster wheels 15 and 16, similarly to FIG. 5. FIG. 6A is a schematic diagram illustrating a state of turn traveling to the front in the vehicle 10. In FIG. 6A, the turning center position 70 is on an outer side of the left and right wheels 12 and on an extended line in a wheel axis direction of the left and right wheels 12 and 13 when viewed from above. At this time, the vehicle 10 turns relatively gently.

FIG. 6B is a schematic diagram illustrating a state in which the vehicle 10 turns around one wheel 12 of the left and right wheels 12 and 13. In FIG. 6B, the turning center position 70 is at the ground contact position of the one wheel 12. Such a turn is called a pivotal turn, and the vehicle 10 turns more quickly than in the case in FIG. 6A.

FIG. 6C is a schematic diagram illustrating a state in which the vehicle 10 turns around the center between the left and right wheels 12 and 13. In FIG. 6C, the turning center position 70 is at the center position between the left and right wheels 12 and 13 on an extended line in the wheel axis direction of the left and right wheels 12 and 13 when viewed from above. The absolute values of the ground movement speeds V1 and V2 of the left and right wheels 12 and 13 are the same, but a direction of the ground movement speed V1 of the one wheel 12 is opposite to a direction of the ground movement speed V2 of the other wheel 13. In this case, the vehicle 10 turns even more quickly than in the case of FIG. 6B. Such a turn is called an ultra-pivotal turn, a spin turn, or a zero turn (ZTR) because the turning radius is zero.

By setting the target revolution speed of the two left and right motors according to the operation position of the two left and right operation levers 22 and 23, the ECU 40 can cause the vehicle 10 to execute both the straight travel illustrated in FIG. 5, and the turn traveling illustrated in FIG. 6A, FIG. 6B, and FIG. 6C.

Further, when one of the two left and right turn switches 54 and 55 is operated, the ECU 40 controls the left motor 30 and the right motor 31 to turn the vehicle 10 to the side of the operated turn switch. At this time, the ECU 40 sets the target revolution speed of each of the left motor 30 and the right motor 31 to turn the vehicle 10 at the target turning radius set by the turning radius dial 36.

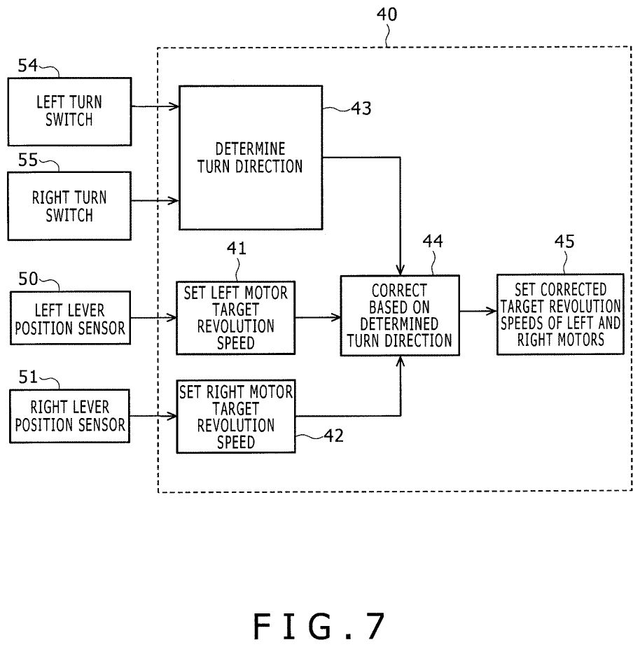

FIG. 7 is a block diagram illustrating a configuration in which the corrected target revolution speeds of the two left and right motors 30 and 31 are set if the turn switches 54 and 55 are operated in the vehicle 10 according to the embodiment. As illustrated in FIG. 7, the ECU 40 includes target revolution speed setting units 41 and 42 for the two left and right motors 30 and 31, a turning direction determination unit 43, a correction unit 44, and a corrected target revolution speed setting unit 45. Detection signals are input to each of the target revolution speed setting unit 41 and 42 from the lever position sensors on the corresponding sides of the two left and right lever position sensors 50 and 51. Detection signals are input to the turning direction determination unit 43 from the two left and right turn switches 54 and 55. If a detection signal indicating that any one of the two left and right turn switches 54 and 55 is operated is input from the one of the two left and right turn switches 54 and 55, the turning direction determination unit 43 determines a side corresponding to the one of the two left and right turn switches 54 and 55 as a turning direction of the vehicle 10. Then, the turning direction determined by the turning direction determination unit 43 is input to the correction unit 44, and the set values of the target revolution speeds of the two left and right motors 30 and 31 are input from the two target revolution speed setting units 41 and 42. The correction unit 44 performs a process for correcting a set value of each target revolution speed so that the vehicle 10 turns at the target turning radius, according to the input turning direction. The correction process also includes correcting only one of the two target revolution speeds. The two corrected target revolution speeds are input to the corrected target revolution speed setting unit 45 and set to the corrected target revolution speed. The ECU 40 performs control to drive the two left and right motors 30 and 31 at the corrected target revolution speed set as described above, or the processed target revolution speed obtained by performing the above filtering process on the corrected target revolution speed.

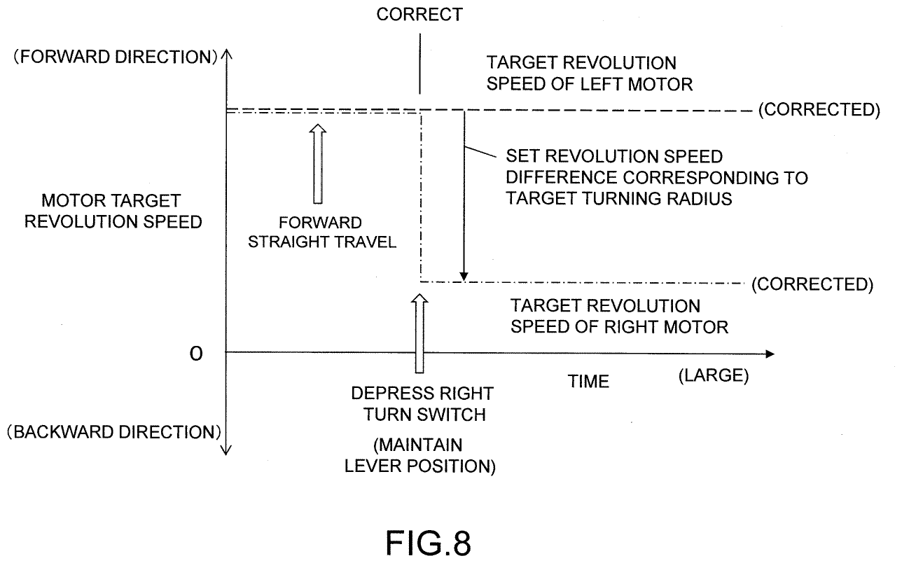

FIG. 8 is a diagram illustrating an example over time in which the corrected target revolution speeds of the two left and right motors 30 and 31 are set if the right-side turn switch 55 (FIG. 3) is operated during forward straight travel. As illustrated in FIG. 8, when the right-side turn switch 55 is operated during forward straight travel, the correction unit 44 (FIG. 7) performs a correction process on the target revolution speeds of the two left and right motors 30 and 31. At this time, the target revolution speed of the left motor 30 is the same before and after the correction process. On the other hand, the target revolution speed of the right motor 31 is set to the corrected target revolution speed obtained by reducing a revolution speed from the target revolution speed of the left motor 30 so that the vehicle 10 turns at a target turning radius set according to an instruction content in the turning radius dial 36. The two left and right motors 30, 31 revolve at the respective corrected target revolution speed or the processed target revolution speed obtained by performing the above filtering process on the corrected target revolution speed. As a result, the rotation speed of the right wheel 13 is lower than the rotation speed of the left wheel 12, so that the vehicle 10 turns to the right. When the left-side turn switch 54 (FIG. 3) is operated, the operation is in much the same way as when the right-side turn switch 55 is operated except that the left and right sides are reversed.

Further, the ECU 40 may control the drive of the left motor 30 and the right motor 31 so that the target turning radius when the turn switches 54 and 55 are operated during straight travel is a length obtained by subtracting a predetermined length from a lawn mowing width of the lawnmower 18 in the left-right direction of the vehicle 10. For example, when the turning radius is specified as any one of Large, Medium, or Small by the turning radius dial 36, the target turning radius may be a length obtained by subtracting a predetermined length from the lawn mowing width.

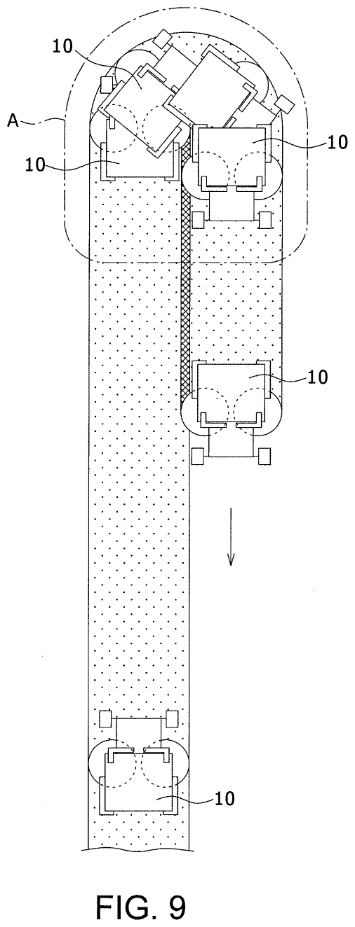

FIG. 9 is a schematic diagram of an example of a state in which the right-side turn switch 55 (FIG. 3) is operated to make a U-turn while performing lawn mowing work in the vehicle 10, as viewed from above with the vehicle 10 assumed to be at traveling positions at a plurality of time points. FIG. 10 is an enlarged diagram of A of FIG. 9. In FIGS. 9 and 10, a portion where a lawn is mowed is illustrated by a sandy soil portion and an oblique grid portion. The oblique grid portion is a portion through which the right lawn mowing blade 18c (FIG. 2) passes in an overlapping manner before and after making a U-turn. In FIG. 10, the rotation trajectories of the two lawn mowing blades 18a and 18c (FIG. 2) on both the left and right ends are indicated by Pa and Pc. As illustrated in FIG. 10, the lawn mowing width of the lawnmower 18 in the left-right direction of the vehicle 10 is a length L1 that is a length between both ends in the left-right direction of the rotation trajectories of the two lawn mowing blades 18a and 18c at both the left and right ends. FIGS. 9 and 10 illustrate a case in which the target turning radius R of the vehicle 10 is a length (L1−D) obtained by subtracting a predetermined length D from the lawn mowing width L1. The predetermined length D is, for example, a value larger than 0 and less than 10 cm, preferably 2 to 5 cm. With such a configuration, when the vehicle 10 travels on the lawn while making a U-turn and performing lawn mowing work, it is easy to eliminate the lawn being left uncut before and after the U-turn. Specifically, the lawn mowing blade 18c passes a portion having a width of 2D (the oblique grid portion in FIGS. 9 and 10) in an overlapping manner before and after making a U-turn, which makes it unlikely that the lawn will be left uncut between the two parallel travel trajectories before and after the U-turn.

Another case is also assumed in which either one of the left and right-side turn switches 54 or 55 is depressed when the vehicle 10 is turned at different operation positions between the F position and the R position of the two operation levers 22 and 23. In this case, the ECU 40 may disable the setting of the target revolution speeds of the two left and right motors 30 and 31 by operating the operation levers 22 and 23, and enable the operation of the turn switch 54 or 55 operated later to set the target revolution speeds of the two left and right motors 30 and 31, based on the operation of the turn switches 54 and 55. Further, the ECU 40 may enable an operation of the turn switch operated later out of the two left and right turn switches 54 and 55, or may disable an operation of the two turn switches 54 and 55, when both the turn switches 54 and 55 are operated at the same time, because the driver's intention is not clear.

The ECU 40 controls the left motor 30 and the right motor 31 to turn the vehicle 10 to the side of the operated quick turn switch when one switch 56 (or 57) of the two left and right quick turn switches 56 and 57 (FIG. 3) is operated. At this time, the ECU 40 controls the left motor 30 and the right motor 31 so that the vehicle 10 makes a quick turn, with the central position between the ground contact positions of the left wheel 12 and the right wheel 13 being the turning center position 70 (FIG. 6C). At this time, the ECU 40 revolves the left motor 30 and the right motor 31 in opposite directions to each other at the same speed so that the left wheel 12 and the right wheel 13 rotate in opposite directions to each other at the same speed. For example, as illustrated in FIG. 6C, the ECU 40 rotates the left wheel in the backward direction at the ground movement speed of V1 and the right wheel in the forward direction at the ground movement speed of V2 having the same magnitude as V1, to enable the vehicle to turn quickly to the left with a zero turn.

According to the vehicle 10 described above, in the vehicle 10 equipped with two left and right operation levers 22 and 23 configured to drive the two left and right wheels 12 and 13, by simply operating the turn switch 54 (or 55) provided on one of the operation levers 22 and 23 without changing the operation amount of the two operation levers 22 and 23, it is possible to turn the vehicle 10 to the side of the operated turn switch. As a result, the frequency with which the driver moves their arm significantly during driving is reduced, so that fatigue of the driver's arm is reduced. For example, the turn switches 54 and 55 may be operated with the thumb of the driver while the driver holds the operation levers 22 and 23.

Further, when the response adjustment dial 37 is operated and at least one of the two operation levers 22 and 23 is operated, the ECU 40 changes the responsiveness in shifting from the current rotation speed of the motor 30 or 31 corresponding to the operated operation levers 22 and 23 to the target rotation speed, according to the operation of the response adjustment dial 37. As a result, the acceleration and deceleration during the operation of the operation levers 22 and 23 can be arbitrarily adjusted according to the user's preference and work content. This improves the ease of driving and working of the user.

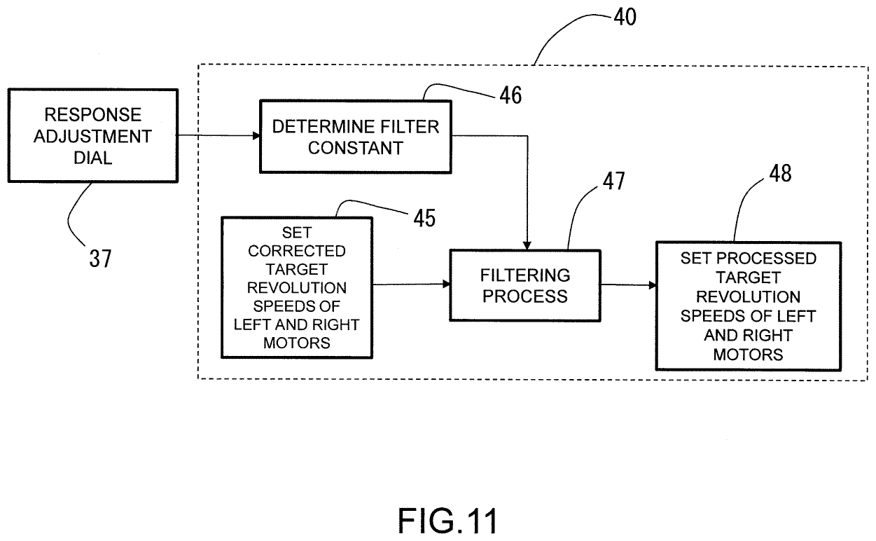

FIG. 11 is a block diagram illustrating a configuration in which target revolution speeds of the two left and right motors 30 and 31 are subject to a filtering process when the response adjustment dial 37 is operated in the vehicle according to the embodiment. As illustrated in FIG. 11, the ECU 40 includes the corrected target revolution speed setting unit 45 for the two left and right motors, a filter constant determination unit 46, a filtering process unit 47, and a processed target revolution speed setting unit 48. A detection signal for switching among the three positions is input from the response adjustment dial 37 to the filter constant determination unit 46. The filter constant determination unit 46 determines a filter constant according to the detection signal. For example, when “Strong” is selected in the response adjustment dial 37, the filter constant is determined to be the largest, when “Weak” is selected, the filter constant is determined to be the smallest, and when “Medium” is selected, the filter constant is determined to be an intermediate constant between “Strong” and “Weak”. The determined filter constant and the corrected target revolution speeds of the two left and right motors 30 and 31 set by the corrected target revolution speed setting unit 45 are input to the filtering process unit 47. The filtering process unit 47 filters the corrected target revolution speeds of each of the motors 30 and 31 by the determined filter constant, and inputs the processed target revolution speeds of each of the motors 30 and 31 to the processed target revolution speed setting unit 48. The processed target revolution speed setting unit 48 sets the input processed target revolution speeds of each of the motors 30 and 31. The ECU 40 performs control so that each of the motors 30 and 31 is driven at the set processed target revolution speed of each of the motors 30 and 31.

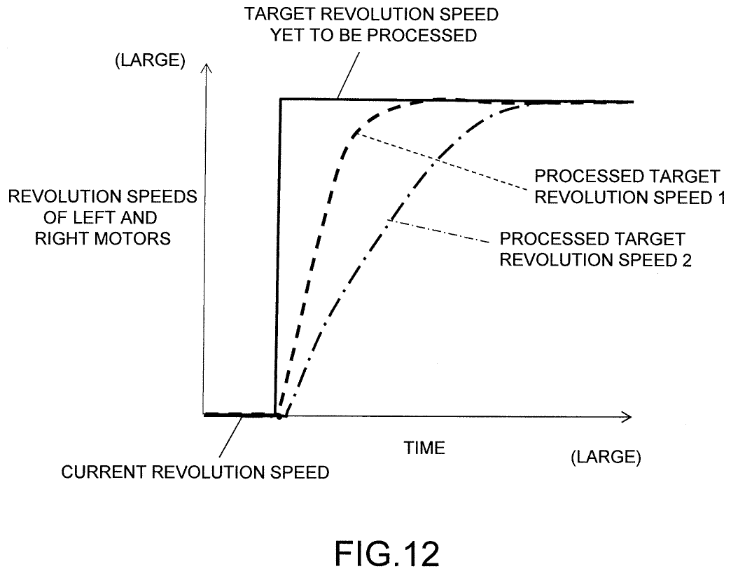

FIG. 12 is a graph showing two examples over time when the target revolution speeds of the two left and right motors 30 and 31 are subject to the filtering process according to an operation of the response adjustment dial 37 in the vehicle 10 according to the embodiment. In FIG. 12, the “processed target revolution speed 1” indicates that “Strong” is selected in the response adjustment dial 37, and the “processed target revolution speed 2” indicates that “Weak” is selected in the response adjustment dial 37. As a result, when “Strong” is selected, the responsiveness of each of the motors 30 and 31 in shifting from the current revolution speed to the target revolution speed is high and the target revolution speed is reached quickly, and therefore, it is seen that the vehicle 10 can be rapidly accelerated or decelerated according to the operation of the operation levers 22 and 23. On the other hand, when “Weak” is selected, the responsiveness of each of the motors 30 and 31 in shifting from the current revolution speed to the target revolution speed is low and the target revolution speed is reached gradually, and therefore, it is seen that the acceleration or deceleration of the vehicle 10 according to the operation of the operation levers 22 and 23 is slow. In FIG. 12, the vertical axis represents the revolution speeds of the left and right motors 30 and 31, and the horizontal axis represents the time, but the vertical axis may represent the vehicle speed of the vehicle 10 instead of the revolution speeds of the left and right motors 30 and 31. In this case, the target vehicle speed is changed according to the operation of the response adjustment dial 37 in much the same way as FIG. 12, and the tendency in such a case is similar to the case of FIG. 12. As a result, according to the embodiment in which the response adjustment dial 37 is provided, the acceleration and deceleration during the operation of the operation levers 22 and 23 can be arbitrarily adjusted according to the user's preference and work content.

On the other hand, the vehicle may not include the response adjustment dial 37, but in this case, the acceleration and deceleration during the operation of the operation levers 22 and 23 cannot be arbitrarily changed by the user. According to the embodiment in which the response adjustment dial 37 is provided, such a point can be improved. The response adjustment dial 37 is not limited to the configuration in which the turn operation tools are provided on the operation levers 22 and 23 as in the embodiment, but may be employed in various configurations in which the travel of the vehicle is operated by the two operation levers 22 and 23.

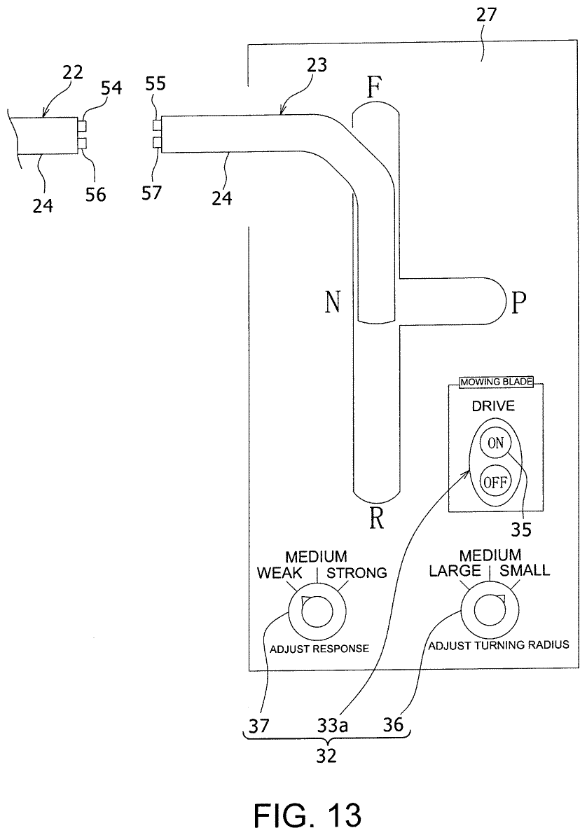

FIG. 13 is a diagram corresponding to FIG. 3 in another example vehicle of the embodiment according to the present disclosure. In the case of the present example, unlike the configurations in FIGS. 1 to 12, the lawn mowing switch 33a includes only the drive changeover switch 35. In the configuration of the present example, by switching the drive changeover switch 35, driving and stopping of the lawnmower 18 can be switched according to an intention of the driver regardless of the position of the operation levers 22 and 23. In the present example, the other configurations are similar to those in FIG. 1 to FIG. 12.

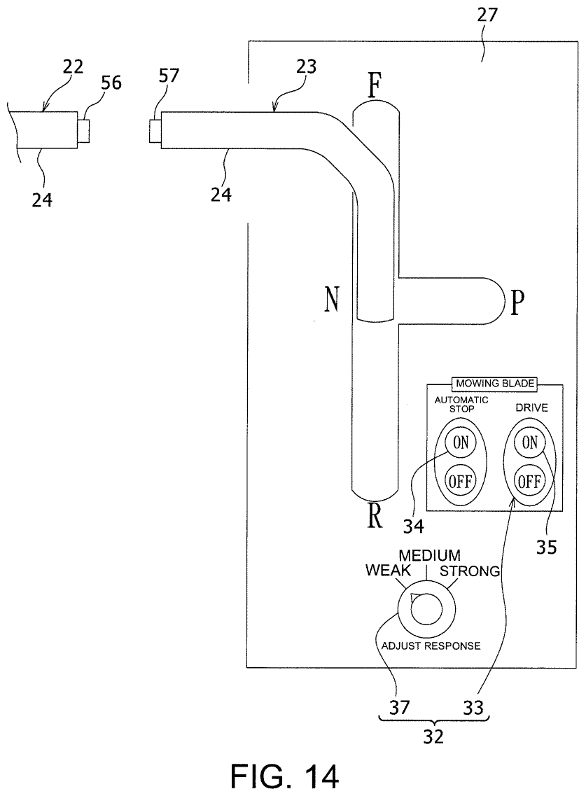

FIG. 14 is a diagram corresponding to FIG. 3 in another example vehicle of the embodiment according to the present disclosure. The vehicle according to the present example does not include the turning radius dial 36 (FIG. 2), unlike the configurations in FIG. 1 to FIG. 12. Further, neither of the two left and right operation levers 22 and 23 are provided with a turn switch, and only the quick turn switches 56 and 57 are provided at the distal end of the respective operation levers 22 and 23. In this configuration, the quick turn switches 56 and 57 correspond to the turn operation tools provided on the operation levers 22 and 23. With this configuration, when the driver operates one of the two quick turn switches 56 and 57 while the vehicle is traveling, the vehicle can turn quickly to the side of the operated quick turn switch, with the center position between the ground contact positions of the left wheel and the right wheel being the turning center. Therefore, in the configuration of the present example, turn traveling using the turn switches cannot be performed, but quick turning using the quick turn switches 56 and 57 can be made without changing the operation amount of the two operation levers 22 and 23. In the present example, the other configurations and operations are similar to those in FIG. 1 to FIG. 12.

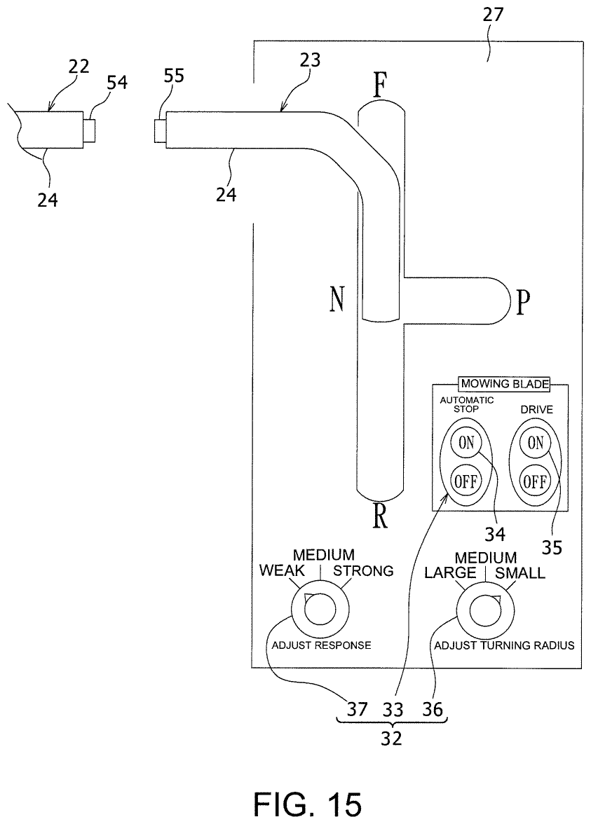

FIG. 15 is a diagram corresponding to FIG. 3 in another example vehicle of the embodiment according to the present disclosure. In the case of the present example, unlike the configurations in FIG. 1 to FIG. 12, neither of the two left and right operation levers 22 and 23 are provided with a quick turn switch, and only the turn switches 54 and 55 are provided at the distal end of the operation levers 22 and 23. Therefore, in the configuration of the present example, quick turn traveling using the quick turn switches cannot be performed, but turn traveling using the turn switches 54 and 55 can be performed. In the present example, the other configurations and operations are similar to those in FIG. 1 to FIG. 12.

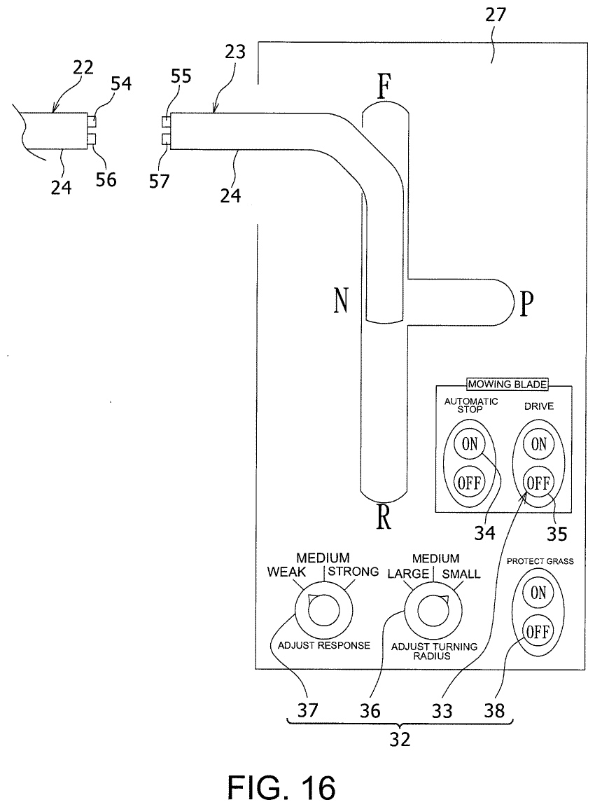

FIG. 16 is a diagram corresponding to FIG. 3 in another example vehicle of the embodiment according to the present disclosure. In the case of the present example, unlike the configurations in FIGS. 1 to 12, the operation element group 32 includes a lawn protection switch 38 to be operated by the driver. The lawn protection switch 38 is arranged on the right side on the guide panel 27. The lawn protection switch 38 can be selectively changed between an ON switch and an OFF switch, and only ON or OFF function of the last operated switch is enabled. The lawn protection switch 38 is connected to the ECU 40 (see FIG. 4) by a signal line. The lawn protection switch 38 corresponds to a lawn protection operation tool.

The ECU 40 sets the target rotation speeds of the left motor 30 (FIG. 2) and the right motor 31 (FIG. 2) according to the operation positions of the two operation levers 22 and 23. When the lawn protection switch 38 is turned ON by the ON switch, and only one of the two operation levers 22 and 23 is operated, the ECU 40 rotates one wheel, out of the left wheel 12 (FIG. 2) and the right wheel 13 (FIG. 2), that is at the inside of a turn at a speed lower than the other wheel, that is at the outside of the turn, to the same side as or opposite with regard to rotational direction to the other wheel at the outer side of the turn. For example, the one inside wheel is rotated at a much lower speed, which does not damage the lawn, or causes less damage, than the other outside wheel. For example, the one inside wheel is rotated at a rotation speed of 1 to 5% of the rotation speed of the other outside wheel. Further, the one inside wheel may be rotated at a predetermined rotation speed corresponding to a predetermined speed where the ground speed is in a range of 1 km/h to 5 km/h.

For example, as in the configurations in FIGS. 1 to 12, without the lawn protection switch, when one of the two operation levers 22 and 23, for example, only the right operation lever 23, is operated in the forward direction, the vehicle is in a state called a pivotal turn in which the vehicle turns around one wheel 12 of the left and right wheels 12 and 13, as illustrated in FIG. 6B. On the other hand, in this case, when the vehicle travels on the grass, particularly if the speed of the other outside wheel 13 increases, the lawn in contact with the ground contact surface of the one inside wheel 12 i is twisted at that position, which may cause damage to the lawn. This leaves room for improvement in terms of enabling turning while protecting grass when traveling on the grass.

In the configuration of the present example, when the lawn protection switch 38 is turned ON, and only one of the two operation levers 22 and 23 is operated, one wheel that is on the inside if the turn, out of the left wheel 12 and the right wheel 13, is rotated to the side same as or opposite to the other wheel that is on the outside if the turn, at a speed lower than the wheel that is on the outside of the turn. As a result, when the vehicle travels on the grass, the one inside wheel moves, which can prevent the lawn from twisting at a position below the one wheel. Therefore, it is possible to prevent damage to the lawn by the one wheel, and thus, the vehicle can turn while protecting the grass. In the present example, the other configurations and operations are similar to those in FIG. 1 to FIG. 12.

In the configurations in FIGS. 1 to 12, the configuration in FIG. 13, or the configuration in FIG. 16, the turn switches 54 and 55, and the quick turn switches 56 and 57 are arranged on the distal end surface of the operation levers 22 and 23 on the same plane. However, to prevent the driver from pressing a wrong switch, it is preferable to separately arrange the turn switches and the quick turn switches on the distal end surface and the outer peripheral surface of the operation levers. At this time, one of each of the turn switches and each of the quick turn switches is arranged on the distal end surface of each of the operation levers 22 and 23, and the other of each of the turn switches and each of the sharp switches is arranged on the outer peripheral surface of each of the operation levers 22 and 23.

The vehicle according to the present disclosure is not limited to the above embodiment, and various modifications may be made within the scope of the claims. For example, in each of the above examples, a case is described in which the operation element group 32 is arranged near a portion where the operation lever 23 on the right side of the driver's seat 21 protrudes, but the operation element group may be arranged near a portion where the operation lever 22 on the left side of the driver's seat 21 protrudes. Further, in each of the above examples, a case is described in which the response adjustment dial 37 is provided in the vehicle 10, but the response adjustment dial 37 may not be provided. In this case, when the operation levers 22 and 23 are operated, the responsiveness of the motors 30 and 31 corresponding to the operated operation levers 22 and 23 in shifting from the current rotation speed to the target rotation speed is a previously set predetermined responsiveness.

Further, a case in which the turn operation tools are the push button-type turn switches 54 and 55 or quick turn switches 56 and 57 is described above, but the turn operation tools may be push-down type switches in which a stroke is switched at a plurality of stages, that is, the stroke is shorter each time the switch is pushed down, and when the switch is pushed down completely, the stroke is returned to the initial long stroke with a spring. In this case, change of the turning radius may be instructed by changing the stroke. For example, the push-down type switches may be configured to instruct the vehicle to set the turning radius to maximum at the initial longest stroke and reduce the turning radius each time the stroke is shortened.

A case in which each of the turn operation tools is a switch is described above. However, the turn operation tool may be a swingable lever provided at the distal end of the operation levers 22 and 23 or the like and configured to instruct the vehicle to turn. Further, a case in which each of the turning radius adjustment tool and the acceleration/deceleration adjustment tool is a dial is described above, but each of the turning radius adjustment tool and the acceleration/deceleration adjustment tool may be a three-point type changeover switch, or a single switch configured to switch according to the number of times it is pressed

Further, each of the above examples describes a case in which the left motor 30 and the right motor 31 are employed for the left continuously variable transmission and the right continuously variable transmission in the vehicle 10, but the vehicle according to the present disclosure is not limited to such a configuration. For example, an output shaft of a hydraulic motor of the left-side hydrostatic continuously variable transmission serving as a left continuously variable transmission may be connected to the left wheel, and an output shaft of a hydraulic motor of the right-side hydrostatic continuously variable transmission serving as a right continuously variable transmission may be connected to the right wheel. Each of the hydrostatic continuously variable transmissions includes a hydraulic pump driven by an engine, a hydraulic motor, and a pair of oil passages for fluidly connecting the hydraulic pump and the hydraulic motor in a closed circuit. The hydraulic motor includes a fixed swash plate, and the hydraulic pump is a volume control type pump including a movable swash plate. By controlling the tilt angle and tilt direction of the movable swash plate, the discharge amount and discharge direction of the hydraulic pump can be changed. Thereby, the rotation direction and the rotation speed of the hydraulic motor can be controlled. The ECU sets the target revolution speed of the two left and right hydraulic motors according to a detection position of the operation positions of the left and right operation levers. Then, according to the respective target revolution speeds, the ECU moves a piston of a hydraulic servo mechanism, which is coupled to move a movable swash plate of the hydraulic pumps of the left and right continuously variable transmissions, by control of a proportional solenoid. As a result, the left wheel and the right wheel are independently driven in terms of the rotation direction and the rotation speed, by an electric left continuously variable transmission and an electric right continuously variable transmission. Further, the ECU controls the drive of the left continuously variable transmission and the right continuously variable transmission according to the operation of the two operation levers. In such a configuration, for example, similarly to the configuration in each of the above examples, when one of the turn operation tools such as the turn switch provided on each of the two operation levers is operated, the ECU controls the left continuously variable transmission and the right continuously variable transmission to turn the vehicle to the side of the operated turn operation tool. As a result, similarly to each of the above examples, the frequency with which the driver moves their arm significantly during driving is reduced.

In the configuration of each of the above examples, along with the turn operation tool, or instead of providing the turn operation tool, the vehicle may be provided with one or both of an acceleration/deceleration adjustment tool such as a response adjustment dial, and a lawn protection operation tool such as a lawn protection switch.

At least one of the above embodiments has the configuration of the first vehicle according to the present disclosure. As a result, in a vehicle equipped with at least one operation tool configured to drive the two left and right wheels, by simply operating the turn operation tool provided on the operation tool without changing the operation amount of the operation tool, it is possible to turn the vehicle to the side of the turn operation tool. Therefore, the frequency with which the driver moves their arm significantly during driving is reduced, so that the fatigue of the driver's arm is reduced. Thus, the above-mentioned first object can be achieved.

At least one of the above embodiments has the configuration of the second vehicle according to the present disclosure. As a result, the acceleration and deceleration during an operation of the operation tool can be arbitrarily adjusted by the user. This improves the ease of driving and working of the user. Thus, the above-mentioned second object can be achieved.

At least one of the above embodiments has the configuration of the third vehicle according to the present disclosure. As a result, when the lawn protection operation tool is operated and the operation tool is operated, one wheel that is on the inside of a turn, out of the left wheel and the right wheel, is rotated to the same side as or opposite with regard to rotational direction to the other wheel which is on the outside of the turn, at a speed lower than the other outside wheel, and therefore, when the vehicle travels on the grass, it is possible to prevent the one wheel from damaging the lawn. Therefore, the vehicle can turn while protecting the grass. Thus, the above-mentioned third object can be achieved.

What is claimed is:

1. A vehicle comprising:
a left continuously variable transmission connected to a left wheel and a right continuously variable transmission connected to a right wheel, the left continuously variable transmission and the right continuously variable transmission being to drive the left wheel and the right wheel independently with regard to a rotation direction and a rotation speed;
at least one operation tool operated to instruct driving of the left wheel and the right wheel;
a control device to control driving of the left continuously variable transmission and the right continuously variable transmission according to an operation of the at least one operation tool; and
a turn operation tool provided on the at least one operation tool, wherein
when the turn operation tool is operated, the control device controls the left continuously variable transmission and the right continuously variable transmission to turn the vehicle to a side of the operated turn operation tool.

2. The vehicle according to claim 1, the at least one operation tool is left and right operation levers, the turn operation tool is mounted on each the operation levers

3. The vehicle according to claim 1, comprising:
a lawnmower, wherein
the control device controls driving of the left continuously variable transmission and the right continuously variable transmission so that a target turning radius when the turn operation tool is operated during straight travel is a length obtained by subtracting a predetermined length from a lawn mowing width of the lawnmower in a left-right direction of the vehicle.

4. The vehicle according to claim 1, comprising:
a turning radius adjustment tool, wherein
the control device changes a target turning radius in a case where the turn operation tool is operated, according to an operation position of the turning radius adjustment tool.

5. The vehicle according to claim 3, comprising:
a quick turn operation tool provided on the at least one operation tool, wherein
if the quick turn operation tool is operated, the control device controls the left continuously variable transmission and the right continuously variable transmission so that the vehicle is turned quickly to a side of the operated quick turn operation tool, around a turn center being a center position between ground contact positions of the left wheel and the right wheel.

6. The vehicle according to claim 1, wherein
the turn operation tool is operable to instruct a quick turn around a turn center being a center position between ground contact positions of the left wheel and the right wheel.

7. The vehicle according to claim 2, wherein
the turn operation tool is electric switch type, arranged to project from a distal end of a corresponding lever of the two left and right operation levers.

8. The vehicle according to claim 7, wherein
a quick turn operation tool provided on the each operation lever of the two left and right operation levers, wherein
if the quick turn operation tool is operated, the control device controls the left continuously variable transmission and the right continuously variable transmission so that the vehicle is turned quickly to a side of the operated quick turn operation tool, around a turn center being a center position between ground contact positions of the left wheel and the right wheel,
the quick turn operation tool is electric switch type, and the quick turn operation tool and the turn operation tool are arranged on the surface of the distal end of the corresponding lever and project therefrom.

9. A vehicle comprising:
a left continuously variable transmission connected to a left wheel and a right continuously variable transmission connected to a right wheel, the left continuously variable transmission and the right continuously variable transmission being to drive the left wheel and the right wheel independently with regard to a rotation direction and a rotation speed;
at least one operation tool operated to instruct driving of the left wheel and the right wheel;
a control device to control driving of the left continuously variable transmission and the right continuously variable transmission according to an operation of the at least one operation tool; and
an acceleration/deceleration adjustment tool, wherein
the control device sets target rotation speed of each of the left continuously variable transmission and the right continuously variable transmission according to operation positions of the at least one operation tool, and if the acceleration/deceleration adjustment tool is operated and the at least one operation tool is operated, the control device changes, according to the operation of the acceleration/deceleration adjustment tool, a responsiveness used when a current rotation speed of the left continuously variable transmission or the right continuously variable transmission corresponding to the operated operation tool shifts to the target rotation speed.

10. A vehicle comprising: a left continuously variable transmission connected to a left wheel and a right continuously variable transmission connected to a right wheel, the left continuously variable transmission and the right continuously variable transmission being to drive the left wheel and the right wheel independently with regard to a rotation direction and a rotation speed;
at least one operation tool operated to instruct driving of the left wheel and the right wheel;
a control device to control driving of the left continuously variable transmission and the right continuously variable transmission according to an operation of the at least one operation tool; and
a lawn protection operation tool, wherein
the control device sets target rotation speeds of the left continuously variable transmission and the right continuously variable transmission according to operation positions of the at least one operation tool, and if the lawn protection operation tool is operated and the operation tool is operated, the control device rotates one wheel that is at an inner side of a turn, out of the left wheel and the right wheel, at a speed lower than that of the other wheel that is at an outer side of the turn, to the same side as or opposite with regard to rotational direction to the other wheel at the outer side of the turn.
